(19) United States
(12) Patent Application Publication
(10) Pub. No.: US 2003/0036434 A1
(43) Pub. Date: Feb. 20, 2003

(54) Manufacturing method of a wooden stick sport device

(76) Inventor: Jerry Wu, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/207,759

(22) Filed: Jul. 31, 2002

(30) Foreign Application Priority Data
Aug. 20, 2001 (TW) 90120581

(51) Int. Cl. A63D 15/08; B29C 63/00

(52) U.S. Cl. 473/44; 264/241; 264/257

(57) ABSTRACT

A manufacturing method of a wooden stick sport device especially for a billiard cue. It comprises the following steps: (1) preparing a wooden stick step, (2) covering with an elastic fiber net step, (3) applying an epoxy coating step, (4) winding a covering stripe step, (5) hardening under room temperature step, (6) taking off the covering stripe step, and (7) completing the final product step. This invention can be manufactured under a room temperature environment. So, the wooden portion will not deform. The defective fraction is low. Its cutting procedure is easy. The final product has no longitudinal seam. It is suitable for any wooden stick with irregular diameter or with special pattern portion. Therefore, it application scope is wider.

### BACKGROUND OF INVENTION

1. Field of the Invention

The present invention relates to a manufacturing method of a wooden stick sport device, and more particularly, to a manufacturing method for a billiard cue under a room temperature environment and its elastic fiber net is seamless.

2. Description of the Prior Art

A typical traditional manufacturing method of a billiard cue (for example the Patent entitled “Manufacturing Method of a Billiard Cue”, Application No. 78107845, Pub. No. 159749, Pub. Date: Jun. 11, 1991 in Taiwan, R.O.C.) is summarized below. Referring to FIGS. 1 and 3, its manufacturing method comprises the following steps:

(1) Preparing a wooden core step 81. By lathe machining, obtain a long rod with a pre-determined diameter (or tapered periphery) as a wooden core 91;

(2) Covering a wrapping layer made by a resin dipped cloth step 82: First, cut the wrapping layer 82 made by a resin dipped cloth into a desired trapezoid-shaped piece. Wrap it on the wooden core 91 so that the wrapping layer 82 is formed.

(3) Winding a covering stripe step 83: Wind a covering stripe 93 on the periphery of the wooden core 91.

(4) High temperature hardening step 84: Place the wooden core 91 into a furnace at a high temperature environment between 120 to 160° C. so that the wrapping layer 82 made by a resin dipped cloth will be hardened.

(5) Taking off the covering stripe step 85: Take off the covering stripe 93.

(6) Completing the final product step 86: The final product is obtained.

Furthermore, the detailed manufacturing processes of the wrapping layer 82 can be seen in FIGS. 2 and 4. It comprises the following steps:

1. Preparing a fiber cloth sheet step 821: Obtain a fiber cloth sheet 921. It has a fixed length and width. It cannot be elastically expanded.

2. Dipped in an epoxy liquid and adding a high-temperature-reacted hardening agent step 822: Make the fiber cloth sheet 921 be dipped in an epoxy liquid. In which, a proper high-temperature-reacted hardening agent is added in to the epoxy liquid. Therefore, when it is in the storage process, selling process or transportation process, the hardening reaction process will not occur.

3. Complete the final product of the wrapping layer 82 made by resin dipped cloth step 823: The wrapping layer 82 is completed. Just wait for the buyer to buy it.

4. Storage/Selling/Transportation step 824: Before the wrapping layer 82 is actually used, there is a waiting period, such as stored in a storage, or placed on a vehicle for delivery.

5. Cutting into a desired trapezoid step 825: Because the billiard cue is a tapered rod. The wrapping layer 82 has to be cut into a desired trapezoid. Once the tapezoid-shaped wrapping layer 82 is wrapped on the periphery of the wooden core 91, the longitudinal seam 95 will be precisely aligned.

However, the major problems or disadvantages of the prior art are:

[1] High temperature hardening causing the wooden portion bending: Everyone knows that wood is a natural material. The wooden core's 91 inner fiber structure, fiber density distribution, internal small spaces are impossible to be uniform. Wood is also very sensitive to the temperature. Usually, when the wooden core 91 is heated above a level between 40 and 60° C., the straight wooden core 91 will start to bend. If the temperature is higher, the bending problem is getting worse. That is, the defective fraction raises. In addition, in order to increase the productive efficiency, the temperature should be higher, so the hardening time of the resin will be shorter. Therefore, the production capacity increases. For example, if the hardening temperature is controlled in the range between 120 to 160° C., assuming total 20000 products, there are approximately 10000 defective products (because of high temperature bending problem). It means the defective fraction is 50%. The production speed is quick, but the overall defective fraction is too high.

[2] Must cut to a trapezoid; it is only suitable for one special size and remains a longitudinal seam: Because the billiard cue is a tapered rod, if the manufacturer wants to wrap on a wrapping layer, this wrapping layer must be cut into a special trapezoid. This cutting procedure is quite time-consuming. Besides, it is only suitable for one size. And, once it is wrapped on the tapered rod, there will be a longitudinal seam. It will influence the appearance of the final product.

[3] It cannot wrap on a billiard cue with irregular portion or with special pattern portion. If the billiard cue is shaped like the one shown in FIG. 8 or FIG. 9, it is impossible (or is very difficult) to make the wrapping layer perfectly cover on the outer surface of the billiard cue. So, its application scope is limited.

### SUMMARY OF THE INVENTION

The primary object of the present invention is to provide a manufacturing method of a wooden stick sport device in which the hardening temperature is just the room temperature. So, the wooden portion will not bend during the manufacturing process. Thus, the defective fraction of the production is low.

Another object of the present invention is to provide a manufacturing method of a wooden stick sport device in which the cutting procedure is easy and there is no longitudinal seam on the final product.

Another object of the present invention is to provide a manufacturing method of a wooden stick sport device. It is suitable for a billiard cure with irregular periphery or with special pattern portion. Thus, it application scope is wider.

### BRIEF DESCRIPTION OF THE DRAWINGS

FIG. 1 is the main flow chart of a prior art.

FIG. 2 is the auxiliary flow chart of a specific procedure of a prior art.

FIG. 3 illustrates the main manufacturing processes of a prior art.

FIG. 4 illustrates the auxiliary manufacturing processes of a specific procedure of a prior art.

FIG. 5 is the flow chart of the present invention.

FIG. 6 illustrates the manufacturing processes of the flow chart of the present invention.

FIG. 7 shows the inner structure of the final product of the present invention.

FIG. 8 is the perspective view of the final product of the second preferred embodiment of the present invention.

FIG. 9 is the perspective view of the final product of the third preferred embodiment of the present invention.

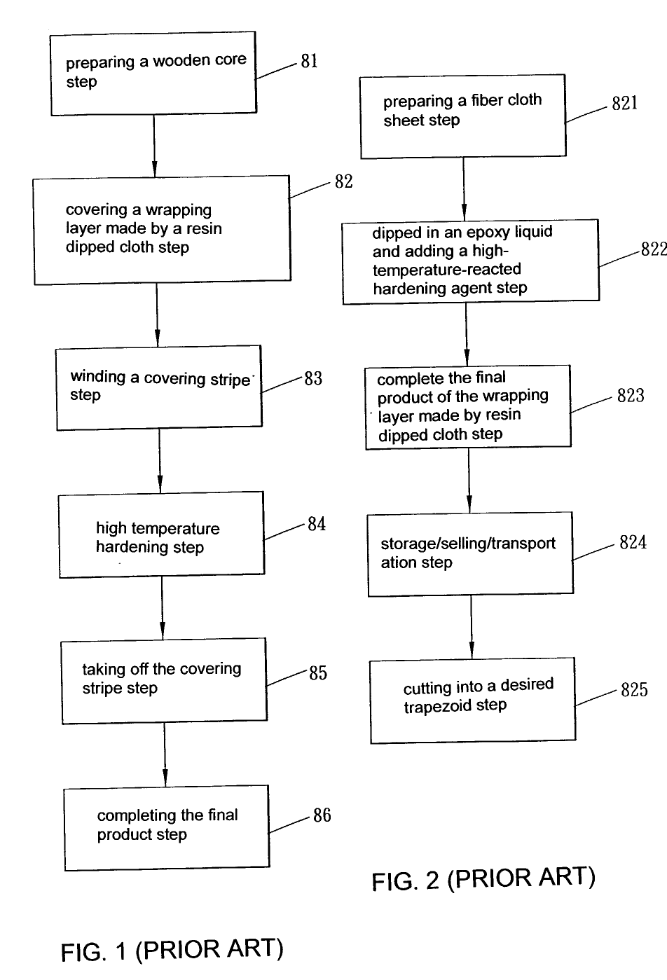

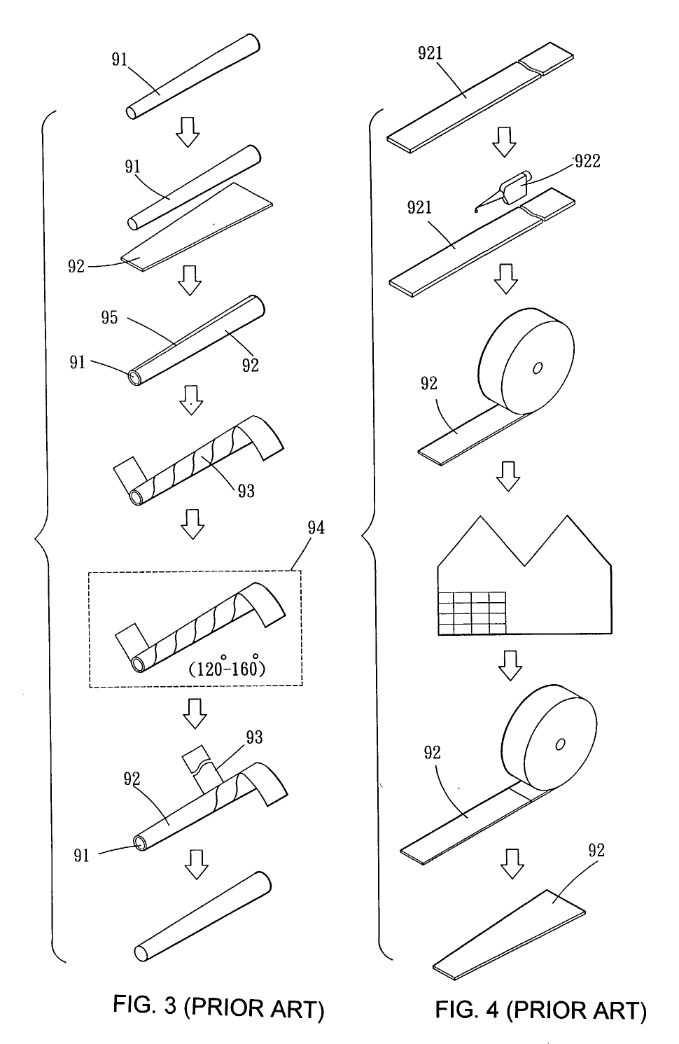

### DETAILED DESCRIPTION OF THE PREFERRED EMBODIMENT

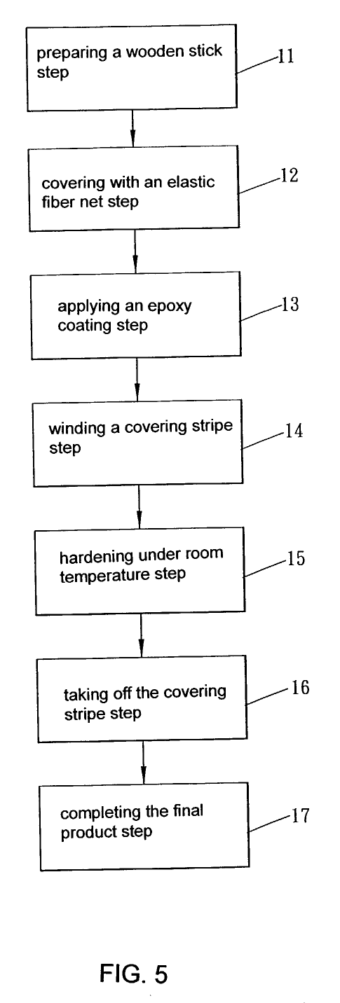

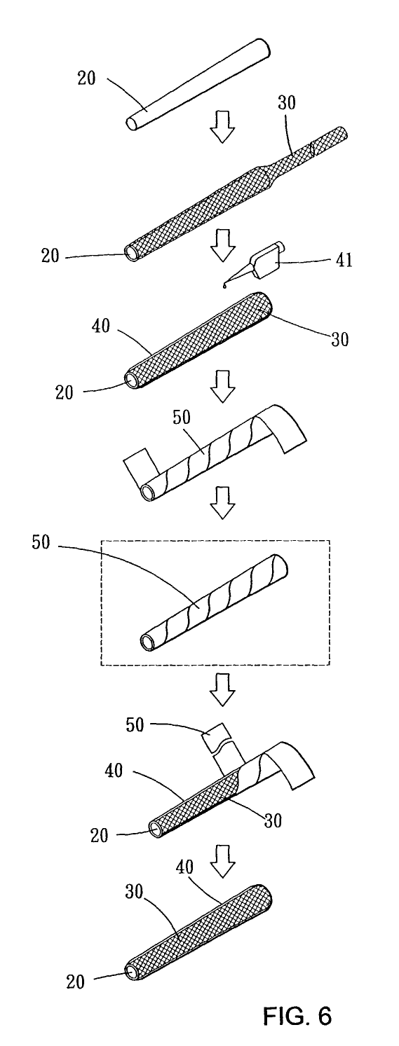

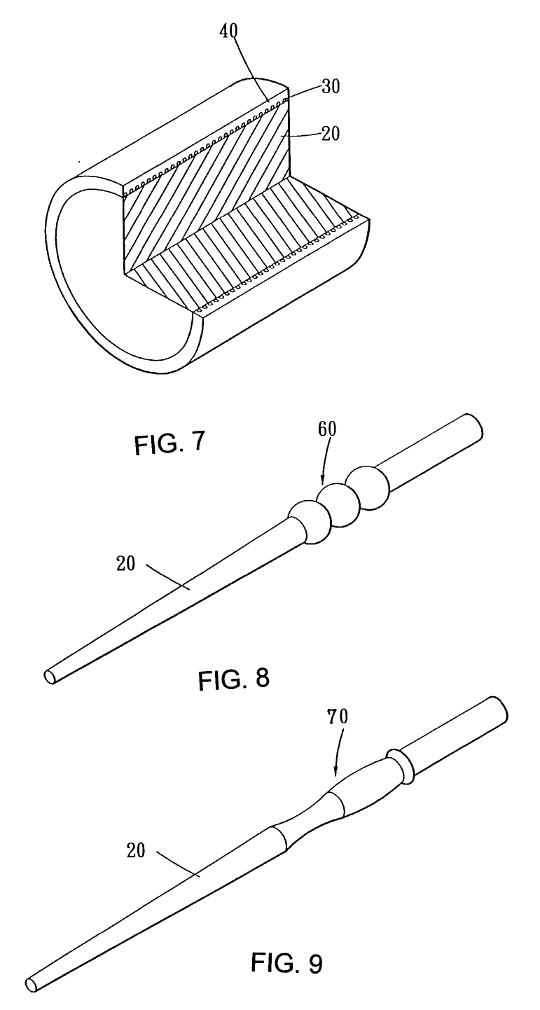

Referring to FIGS. 5 to 7, this invention relates to a manufacturing method of a wooden stick sport device, especially for a billiard cue. It comprises the following steps:

(1) preparing a wooden stick step 11: By lathe machining, obtain a wooden stick 20.

The wooden stick 20 is substantially a straight rod with a slightly tapered periphery.

(2) covering with an elastic fiber net step 12: to fit a pipe-like elastic fiber net 30 on the slightly tapered periphery of the wooden stick 20. Then, the elastic fiber net 30 automatically firmly fits on the wooden stick 20. After which, cut out the extra portion of the fitted elastic fiber net 30.

(3) applying an epoxy coating step 13: Apply an epoxy coating 41 on the wooden stick 20 covered with the elastic fiber net 30. Or, let the wooden stick 20 be immersed (or dipped) in an epoxy liquid for a while, so that such epoxy coating 41 can be obtained.

(4) winding a covering stripe step 14: wind a covering stripe 14 around the wooden stick 20 to isolate the epoxy coating 41 on the wooden stick 20.

(5) hardening under room temperature step 15: Make the epoxy coating 41 be gradually hardened and become solid under a room temperature environment for a pre-determined time. So, a hardening layer 40 is formed.

(6) taking off the covering stripe step 16: to take off the covering stripe 50.

(7) completing the final product step 17: Obtain the final product of a wooden stick sport device (such as a billiard cue).

In which, the pipe-like elastic fiber net 30 is expandable or shrinkable to firmly fit on a wooden stick 20 having an outer diameter usually between 0.5 cm and 10 cm.

Please note that the pipe-like elastic fiber net 30 has a tilted cross net structure. There is no longitudinal (or axial) seam to connect to. There are small gaps between every two adjacent tilted cross fiber lines. This kind of tilted cross net structure is quite elastic because it can be automatically expanded to firmly fit on a wooden stick 20. If the diameter is larger, the elastic fiber net 30 will be expanded larger, and vice versa. Thus, the elastic fiber net 30 can automatically fit the regular or irregular periphery of the wooden stick 20.

In addition, because the epoxy coating 41 is formed after the applying an epoxy coating step 13 and immediately continued by hardening under room temperature step 15, there is no storage time nor transportation time needed. Therefore, the epoxy coating 41 (or epoxy liquid) only needs to add some hardening agent that will react under a room temperature environment. Thus, the hardening temperature for the epoxy coating 41 is just the room temperature. It will complete avoid the wooden stick bending problem caused by the high temperature.

Referring to FIG. 8, it is the second preferred embodiment of this invention. In which, the slightly tapered periphery of the wooden stick 20 further having an irregular-shaped first pattern portion 60. However, because the elastic fiber net 30 can automatically deform to firmly fit on the first pattern portion 60. So, there is no any difficulty for manufacturing such wooden stick sport device.

Referring to FIG. 9, it is the third preferred embodiment of this invention. In which, the slightly tapered periphery of the wooden stick 20 further having an irregular-shaped second pattern portion 70. As explained above, because the elastic fiber net 30 can automatically deform to firmly fit on the second pattern portion 70. So, there is no any difficulty for manufacturing such wooden stick sport device.

Therefore, the advantages and functions can be summarized as follows:

1. Room-temperature hardening, no heat deformation occurring: This invention can be manufactured under a room temperature environment. So, the wooden portion will not deform. Once it is hardened, the wooden stick of the final product is still very straight. So, the production quality is high.

2. The cutting procedure is easy and the elastic fiber net is seamless: In this invention, only the two ends of the elastic fiber net will be cut out. There is no any longitudinal seam. Such cutting procedure is easy. Furthermore, There is no connecting problem for the longitudinal seam.

3. It is suitable for the wooden stick with irregular diameter or with special pattern portion. Since the elastic fiber net can automatically expanded to fit the outer surface of the wooden stick, no matter it has a tapered shape, irregular diameter, or special designed pattern, this invention is suitable for all. So, its application scope is wide.

The above embodiments are only used to illustrate the present invention, not intended to limit the scope thereof Many modifications of the above embodiments can be made without departing from the spirit of the present invention.

What is claim is:

1. A manufacturing method of a wooden stick sport device, comprising the following steps:
(1) preparing a wooden stick step: by lathe machining, to obtain a wooden stick which is substantially a straight rod with a slightly tapered periphery;
(2) covering with an elastic fiber net step: to fit an pipe-like elastic fiber net on the slightly tapered periphery of said wooden stick, then said elastic flexible fiber net automatically firmly fitting on said wooden stick, after which, to cut out the extra portion of said fitted elastic fiber net;
(3) applying an epoxy coating step: to apply an epoxy coating on said wooden stick covered with said elastic fiber net,
(4) winding a covering stripe step: to wind a covering stripe around said wooden stick to isolate said epoxy coating on said wooden stick;
(5) hardening under room temperature step: to make said epoxy coating be gradually hardened and become solid under a room temperature environment for a predetermined time;
(6) taking off the covering stripe step: to take off covering said stripe; and
(7) completing the final product step: to obtain a final product of a wooden stick sport device.

2. A manufacturing method of a wooden stick sport device as claimed in claim 1, wherein said pipe-like elastic fiber net is expandable or shrinkable to fit on a wooden stick having an outer diameter between 0.5 cm and 10 cm.

3. A manufacturing method of a wooden stick sport device as claimed in claim 1, wherein said slightly tapered periphery of said wooden stick further having an irregular-shaped pattern portion which also is covered by said elastic fiber net.
